(19) United States
(12) Patent Application Publication
(10) Pub. No.: US 2008/0226089 A1
(43) Pub. Date: Sep. 18, 2008

(54) DYNAMIC TECHNIQUE FOR CUSTOM-FIT HEARING DEVICES

(75) Inventors: Menachem Levanoni, Poway, CA (US); Jerome M. Kurtzberq, Yorktown Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 12/115,590

(22) Filed: May 6, 2008

Related U.S. Application Data
(63) Continuation of application No. 11/081,269, filed on Mar. 16, 2005.

(51) Int. Cl. H04R 29/00

(52) U.S. Cl. 381/60

(57) ABSTRACT

A method for providing optimal dynamic techniques for custom-fit ear hearing devices, includes mounting pressure and motion sensors in a ear-enclosing hearing device, transmitting data produced by the sensors during actual operation of the ear-enclosing hearing device worn by a specific individual, receiving the sensor signals for subsequent analysis by a computer, creating a stress-and-motion map based on the sensor-based data, and creating a virtual hearing device model for optimal support and comfort based on the stress-and-motion map.

### CROSS REFERENCE TO RELATED APPLICATIONS

The present application is a Continuation Application of U.S. patent application Ser. No.: 11/081,269 filed on Mar. 16, 2005. The instant application is related to U.S. patent application Ser. No. 11/083,729, filed Mar. 18, 2005 by Levanoni, et al.; and the U.S. patent application Ser. No. 11/082,666 filed Mar. 17, 2005 by Levanoni, et al. These applications are co-pending, commonly assigned, and incorporated by reference herein.

### BACKGROUND OF THE INVENTION

1. Field of the Invention

This invention relates to methodology for utilizing continual sensor-based data to design and adjust hearing devices to fit an individual, in a given dynamic environment, in an efficient manner.

2. Introduction to the Invention

Static fitting techniques to design and construct hearing devices for specific people are known. An aural test is taken, and a hearing device is produced based on that test.

### SUMMARY OF THE INVENTION

However, in this context, we have discerned that no attention is given to the dynamic workings of the ear in the changing real environment. Specifically, the stresses and accelerations experienced by the ear during normal operation are not taken into account, nor is the optimum balance, between low frequency and high frequency hearing, taken into account.

We have now discovered novel methodology for exploiting the advantages inherent generally in sensing the dynamic workings (stresses) on specific ears in actual motion, and using the sensor-based data, preferably to optimize the design and construction of the desired hearing devices.

Our work proceeds in the following way.

We have recognized that a typical and important paradigm for presently effecting hearing device construction, is a largely static and subjective, human paradigm, and therefore exposed to all the vagaries and deficiencies otherwise attendant on static and human procedures. Instead, the novel paradigm we have in mind, works in the following way:

First, a patient wears a set of pressure and movement sensors mounted, say, inside a ear-encasing hearing device. These sensors record their associated stresses and ear-movement produced in normal individual motion in its dynamic environment for a prescribed period of time sufficient to capture all possible stress and ear-movement patterns.

The dynamically acquired data are fed into a computer which creates a map of the forces and ear-motion experienced by the examined ear. This information can be used to design an optimal hearing device, which can maximize hearing and minimize discomfort, thereby resulting in a computer production of a virtual hearing device that can offer optimal performance to the examined ear in its normal operation.

A physical hearing device may then be produced from a model provided by the virtual hearing device. This physical hearing device can provide maximum vision and maximal comfort to its wearer, following the optimal design of the hearing device.
We now disclose a novel method which can preserve the advantages inherent in the static approach, while minimizing the incompleteness and attendant static nature and subjectivities that otherwise inure in a technique heretofore used.

To this end, in a first aspect of the present invention, we disclose a novel method comprising the steps of:
i) mounting pressure and motion sensors in a ear-enclosing hearing device;
ii) transmitting data produced by said sensors during actual operation of said ear-enclosing hearing device worn by a specific individual;
iii) receiving said sensor signals for subsequent analysis by a computer;
iv) creating a computer stress-and-motion map based on said sensor-based data; and
v) creating a virtual hearing device (model) for optimal support and comfort based on step iv stress-and-motion map.

The novel method preferably comprises a further step of actually constructing said physical hearing device.

### BRIEF DESCRIPTION OF THE DRAWING

The invention is illustrated in the accompanying drawing, in which

FIG. 1 (numerals 10-34) provides an illustrative flowchart comprehending overall realization of the method of the present invention, including details of individual components.

### DETAILED DESCRIPTION OF THE PRESENT INVENTION

### Typical Application

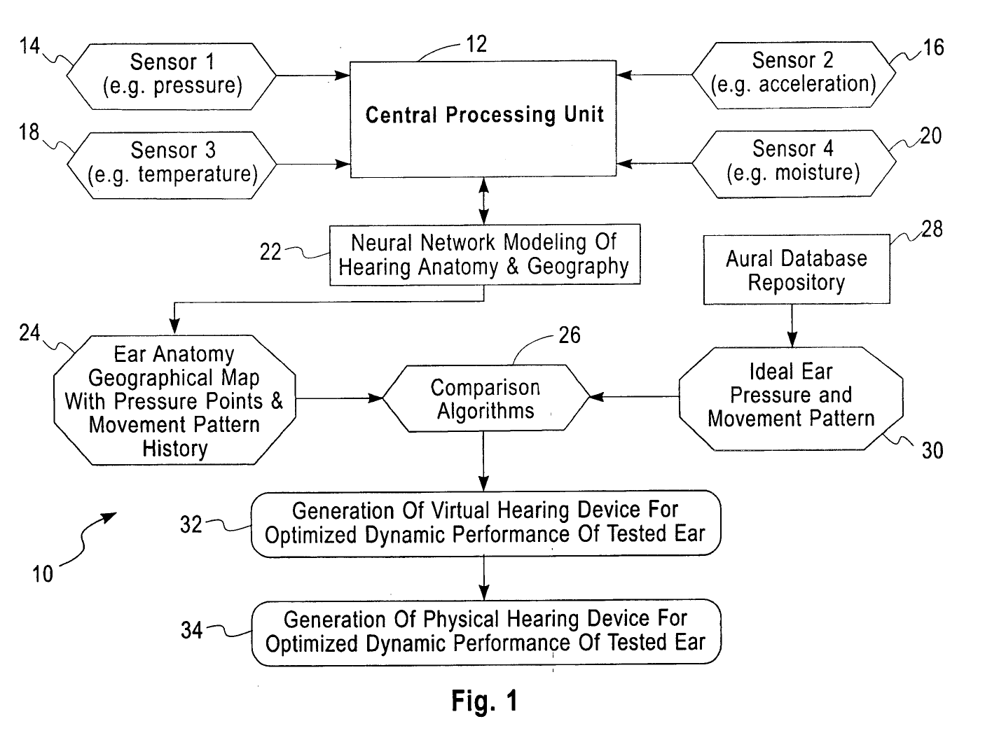

In a typical case (and with reference to FIG. 1, numerals 10-34), the patient's ear is fitted with a temporary hearing device containing a number of sensors, located at prescribed locations on the tested ear. These sensors, which include pressure, motion, temperature, and humidity, are connected to a recording hearing device.

The patient is asked to wear the hearing device for several days and follow his/her normal routine.

During the test period, sensors data are recorded (including time stamps) in the recording hearing device. The patient returns the hearing device and the recording hearing device at the end of the test period. The information stored in the recording hearing device is then downloaded to a computer which stores all data in a database.

The data are then analyzed by a program (preferably a neural network modeling program) which creates maps of the tested ear at different times. These maps also contain the sensors' reading at these times. Thus, the system now has information on the dynamic behavior of the tested ear, including parametric information.

Based on these maps and maps of an ideal ear under similar conditions, an optimization program designs an optimized virtual hearing device for the patient. This design is then fed to a machine which generates an optimized physical hearing device.

What is claimed:

1. A method comprising the steps of:
i) mounting pressure and motion sensors in an ear-enclosing hearing device;
ii) transmitting data, as sensor signals, produced by said sensors during actual operation of said ear-enclosing hearing device worn by a specific individual;
iii) receiving said sensor signals for subsequent analysis by a computer;
iv) creating a stress-and-motion map based on said sensor-based data; and
v) creating a virtual hearing device model for optimal support and comfort based on the stress-and-motion map.

2. A method according to claim 1, further comprising using a temperature sensor which is correlated with vision and comfort of a worn hearing device.

3. A method according to claim 1, further comprising using an interpolation technique to completely map stresses and motions experienced by an ear over a period of time, to produce an interpolation map.

4. A method according to claim 3, further comprising updating the virtual hearing device model using the interpolation map.

5. A method according to claim 3, further comprising using the interpolation map to directly design the virtual hearing device in an optimal manner.

6. A method according to claim 1, further comprising using a non-linear technique to model an hearing device.

7. A method according to claim 6, further comprising employing neural networks as the modeling technique.

8. A method according to claim 6, further comprising employing regression as the modeling technique.
